(19) United States
(12) Patent Application Publication
(10) Pub. No.: US 2012/0075865 A1
(43) Pub. Date: Mar. 29, 2012

(54) LENS AND LIGHT SOURCE MODULE

(75) Inventor: HSIU-PING CHANG, Chu-Nan (TW)

(73) Assignee: FOXSEMICON INTEGRATED TECHNOLOGY, INC., Chu-Nan (TW)

(21) Appl. No.: 13/233,170

(22) Filed: Sep. 15, 2011

(30) Foreign Application Priority Data
Sep. 23, 2010 (CN) 201010289366.7

(51) Int. Cl. F21V 5/04; F21V 7/00

(52) U.S. Cl. 362/296.01; 362/311.1; 362/335; 362/327

(57) ABSTRACT

A lens includes a light incident surface with a first central axis, a first light emitting surface, and a second light emitting surface. The first light emitting surface is a convex, curved surface with a second central axis and is opposite to the light incident surface; the first light emitting surface comprises a first border. The first light emitting surface and the light incident surface cooperatively forming a convex lens portion. The second light emitting surface is located at a side of the first light emitting surface adjacent to the first border. The second light emitting surface is a rough surface for refracting light randomly. The distance between the first central axis and an inner side of the second light emitting surface is larger than the distance between the second central axis and the inner side of the second light emitting surface.

### BACKGROUND

1. Technical Field

The present disclosure relates to optical field and, particularly, to a lens and a light source module having the lens.

2. Description of Related Art

At present, the light emitted from many types of light sources, such as light emitting diodes, discharge lamps, and halogen lamps etc., has a large divergence angle. When one of these types of light sources is provided for long-distance illumination, a focus lens is generally required at the front of it to reduce the divergence angle and focus the light near the optical axis. However, in some products, such as vehicle lamp etc., not only long-distance illumination for illuminating the distant place ahead of the vehicle is needed, but short-distance illumination for illuminating the ground near the vehicle is also needed. Therefore, the conventional focus lens could not satisfy the above described application.

What is needed is a lens which can ameliorate the problem of the prior art.

### BRIEF DESCRIPTION OF THE DRAWINGS

Many aspects of the present lens and light source module can be better understood with reference to the accompanying drawings. The components in the drawings are not necessarily drawn to scale, the emphasis instead being placed upon clearly illustrating the principle of the lens and light source module. In the drawings, all the views are schematic.

FIG. 1 is a schematic view of a light source module according to an exemplary embodiment.

FIG. 2 is a schematic view of a lens of the light source module of FIG. 1 viewed from another aspect.

FIG. 3 is a cross sectional view of the light source module taken along line III-III of FIG. 1.

### DETAILED DESCRIPTION

Embodiments of the present disclosure will now be described in detail below, with reference to the accompanying drawings.

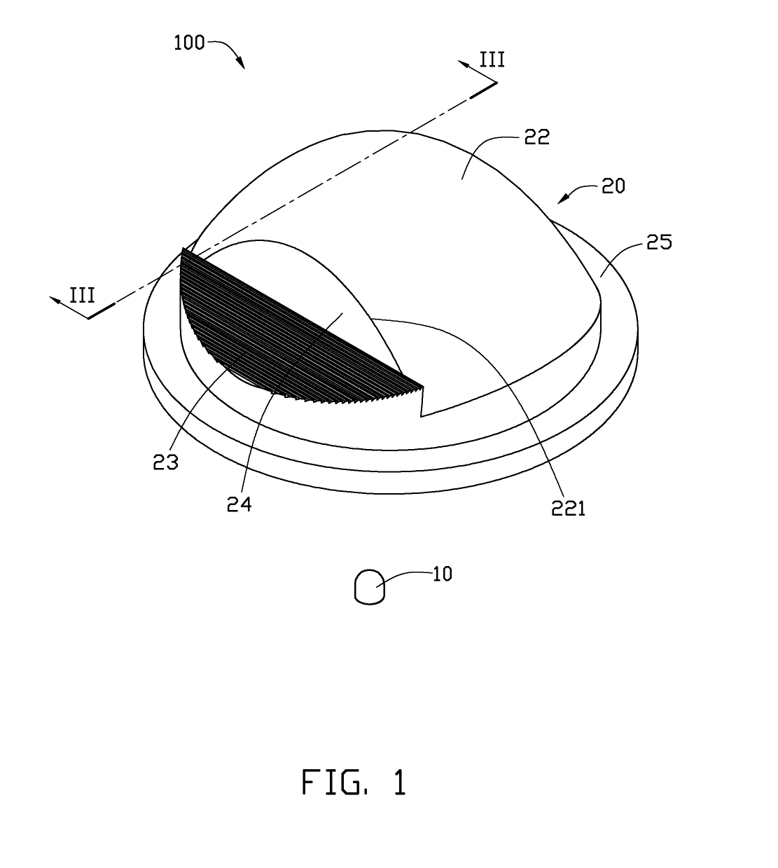

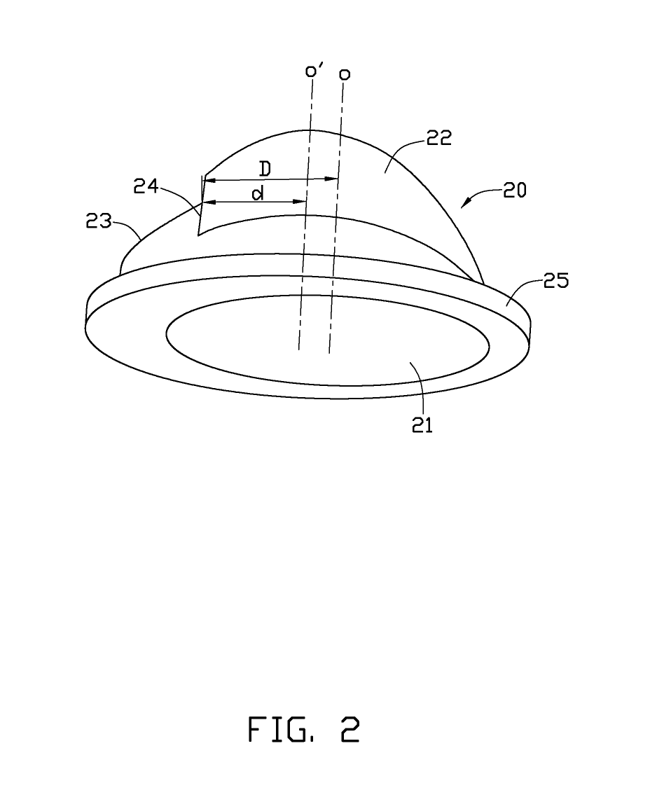

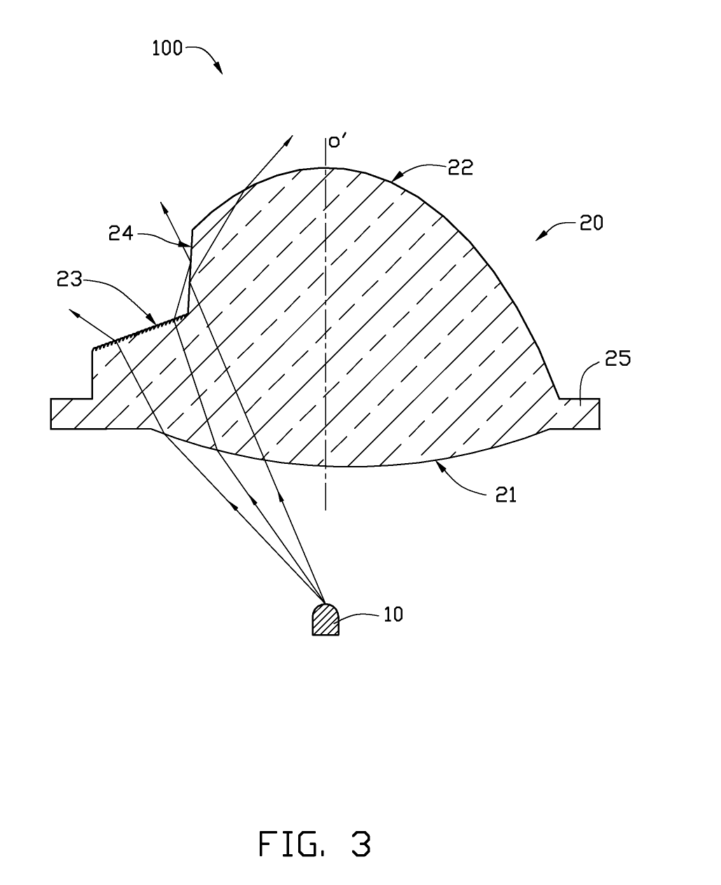

Referring to FIGS. 1 to 3, a light source module 100 according to an exemplary embodiment is shown. The light source module 100 includes a light source 10 and a lens 20. The light source 10 can be a light emitting diode, a discharge lamp, or a halogen lamp etc. The light source module 100 can be used in vehicle lamps etc.

The lens 20 includes a light incident surface 21 facing the light source 10, a first light emitting surface 22, a second light emitting surface 23, and a connecting surface 24. The connecting surface 24 connects the first light emitting surface 22 to the second light emitting surface 23. The first light emitting surface 22 and the second light emitting surface 23 are opposite to the light incident surface 21.

The light incident surface 21 can be a convex surface, a concave surface or a flat surface. In the present embodiment, the light incident surface 21 is a convex, curved surface with a first central axis O.

The first light emitting surface 22 is a convex, curved surface. The first light emitting surface 22 and the light incident surface 21 cooperatively form a convex lens portion; the convex lens portion can focus the light emitted from the light source 10. The light emitted from the light source 10 has a relatively small divergence angle after being focused by the convex lens portion, and thus can be used for long-distance illumination. When the light source module 100 is used in a vehicle lamp, the light emitted from the first light emitting surface 22 can be used for illuminating the distant place ahead of the vehicle. The first light emitting surface 22 has a second central axis O′ substantially parallel to the first central axis O. The distance D between the first central axis O of the light incident surface 21 and an inner side of the second light emitting surface 23 is different from the distance d between the second central axis O′ of the first light emitting surface 22 and the inner side of the second light emitting surface 23. The shorter the distance D is, the more amount of light emitted from the second light emitting surface 23 is. Therefore, the amount of light generated by the light source 10 and emitted from the second light emitting surface 23 can be controlled by controlling the distance D. In the present embodiment, the distance D is bigger than the distance d; thus, there will be more amount of light emitted from the first light emitting surface 23 for long-distance illumination. The first light emitting surface 22 includes a first border 221.

The second light emitting surface 23 is located at a side of the first light emitting surface 22 adjacent to the first border 221. The second light emitting surface 23 is a rough surface and defines a plurality of serrations thereon. The light incident on the rough surface from the light source 10 can be refracted randomly; therefore, the light emitted from the second light emitting surface 23 has a large divergence angle. When the light source module 100 is used in a vehicle lamp, the second light emitting surface 23 can be arranged at a side of the first light emitting surface 22 adjacent to the ground, and the light emitted from the second light emitting surface 23 can be used for short-distance illumination to illuminate the ground.

In the present embodiment, the projection area of the second light emitting surface 23 on a plane perpendicular to the second central axis O′ is smaller than that of the first light emitting surface 22; thus, most of the light emitted from the light source 10 can be used for long-distance illumination.

The connecting surface 24 can reflect the light incident thereon from the light source 10 towards the first light emitting surface 22 for long-distance illumination. In the present embodiment, the light connecting surface 24 is substantially parallel to the second central axis O′, whereby most of the light incident on the connecting surface 24 experiences a total reflection. The light connecting surface 24 can further have a light reflective film formed thereon; thus, the light connecting surface 24 not only can be used for reflecting the light incident thereon from the light source 10 towards the first light emitting surface 22 for long-distance illumination, but also can be used for reflecting the light emitted from the second light emitting surface 23 to deflect away from the second central axis O′ for short-distance illumination.

In the present embodiment, the lens 20 further includes a ring-shaped protrusion 25 protruding outwardly from a circumference surface of the lens 20. The ring-shaped protrusion 25 is configured for holding the lens 20 conveniently. In the present embodiment, the projections of the first light emitting surface 22, the second light emitting surface 23, and the connecting surface 24 on the plane perpendicular to the second central axis O′ cooperatively form a circle.

While certain embodiments have been described and exemplified above, various other embodiments will be apparent to those skilled in the art from the foregoing disclosure. The disclosure is not limited to the particular embodiments described and exemplified, and the embodiments are capable of considerable variation and modification without departure from the scope and spirit of the appended claims.

What is claimed is:

1. A lens comprising:
a light incident surface with a first central axis;
a first light emitting surface, the first light emitting surface being a convex, curved surface with a second central axis and opposite to the light incident surface, the first light emitting surface comprising a first border, the first light emitting surface and the light incident surface cooperatively forming a convex lens portion; and
a second light emitting surface located at a side of the first light emitting surface adjacent to the first border, the second light emitting surface being a rough surface for refracting light randomly, the distance between the first central axis and an inner side of the second light emitting surface being different from the distance between the second central axis and the inner side of the second light emitting surface.

2. The lens as claimed in claim 1, wherein the light incident surface is a convex, curved surface.

3. The lens as claimed in claim 1, wherein the distance between the first central axis and the inner side of the second light emitting surface is larger from the distance between the second central axis and the inner side of the second light emitting surface.

4. The lens as claimed in claim 1, wherein the first central axis is substantially parallel to the second central axis.

5. The lens as claimed in claim 1, wherein the lens is used in a vehicle lamp, and the second light emitting surface is arranged at a side of the first light emitting surface adjacent to the ground.

6. The lens as claimed in claim 1, wherein the projection area of the second light emitting surface on a plane perpendicular to the second central axis is smaller than that of the first light emitting surface.

7. The lens as claimed in claim 1, wherein the lens further comprises a connecting surface connecting the first light emitting surface to the second light emitting surface.

8. The lens as claimed in claim 7, wherein the connecting surface is substantially parallel to the second central axis.

9. The lens as claimed in claim 7, wherein the light connecting surface has a light reflective film formed thereon.

10. The lens as claimed in claim 7, wherein the projections of the first light emitting surface, the second light emitting surface, and the connecting surface on a plane perpendicular to the second central axis cooperatively form a circle.

11. A light source module comprising:
a light source; and
a lens, the lens comprising:
a light incident surface facing the light source, the light incident surface having a first central axis;
a first light emitting surface, the first light emitting surface being a convex, curved surface with a second central axis and opposite to the light incident surface, the first light emitting surface comprising a first border, the first light emitting surface and the light incident surface cooperatively forming a convex lens portion; and
a second light emitting surface located at a side of the first light emitting surface adjacent to the first border, the second light emitting surface being a rough surface for refracting light randomly, the distance between the first central axis and an inner side of the second light emitting surface being different from the distance between the second central axis and the inner side of the second light emitting surface.

12. The light source module as claimed in claim 11, wherein the light incident surface is a convex, curved surface.

13. The light source module as claimed in claim 11, wherein the distance between the first central axis and the inner side of the second light emitting surface is larger than the distance between the second central axis and the inner side of the second light emitting surface.

14. The light source module as claimed in claim 11, wherein the first central axis is substantially parallel to the second central axis.

15. The light source module as claimed in claim 11, wherein the lens is used in a vehicle lamp, and the second light emitting surface is arranged at a side of the first light emitting surface adjacent to the ground.

16. The light source module as claimed in claim 11, wherein the projection area of the second light emitting surface on a plane perpendicular to the second central axis is smaller than that of the first light emitting surface.

17. The light source module as claimed in claim 11, wherein the lens further comprises a connecting surface connecting the first light emitting surface to the second light emitting surface.

18. The light source module as claimed in claim 17, wherein the connecting surface is substantially parallel to the second central axis.

19. The light source module as claimed in claim 17, wherein the light connecting surface has a light reflective film formed thereon.

20. The light source module as claimed in claim 17, wherein the projections of the first light emitting surface, the second light emitting surface, and the connecting surface on a plane perpendicular to the second central axis cooperatively form a circle.
